(19) United States
(12) Patent Application Publication
(10) Pub. No.: US 2006/0063070 A1
(43) Pub. Date: Mar. 23, 2006

(54) Positive electrode active material, positive electrode and nonaqueous electrolyte secondary battery

(76) Inventors: Takanobu Chiga, Kobe-shi (JP); Atsushi Yanai, Kobe-shi (JP); Yoshinori Kida, Kobe-shi (JP); Toshiyuki Nohma, Kobe-city (JP)

Correspondence Address: KUBOVCIK & KUBOVCIK, SUITE 710, 900 17TH STREET NW, WASHINGTON, DC, 20006, US

(21) Appl. No.: 11/231,969

(22) Filed: Sep. 22, 2005

(30) Foreign Application Priority Data
Sep. 22, 2004 (JP) 2004-274428

(51) Int. Cl. H01M 4/52; C01G 51/04

(52) U.S. Cl. 429/231.1; 423/594.6

(57) ABSTRACT

A positive electrode active material for a nonaqueous electrolyte secondary battery comprising a lithium-transition metal oxide having a layered structure and containing at least cobalt as a transition metal, wherein at least part of the surface of the lithium-transition metal oxide is coated by a treatment layer comprising low-temperature phase lithium cobalt oxide.

### FIELD OF THE INVENTION

The present invention relates to a positive electrode active material for a nonaqueous electrolyte secondary battery, and a positive electrode and nonaqueous electrolyte secondary battery using the same.

### BACKGROUND OF THE INVENTION

In recent years nonaqueous electrolyte secondary batteries using a metallic lithium or an alloy that occludes or releases lithium ions or a carbon material or the like as a negative electrode material and a lithium-transition metal oxide represented by the chemical formula LiMO₂ (where M is a transition metal) as a positive electrode active material have attracted attention as batteries having high energy density. Cyclic carbonates such as ethylene carbonate and propylene carbonate, cyclic esters such as γ-butyrolactone, chain carbonates such as dimethyl carbonate and ethylmethyl carbonate have been used alone or in a combination thereof as electrolytes for these batteries.

Lithium cobalt oxide (LiCoO₂) can be illustrated as a typical example of a lithium-transition metal oxide and has been used as a positive electrode active material for a nonaqueous electrolyte secondary battery. However, if a lithium-transition metal oxide having a layered structure, of which lithium cobalt oxide is typical, is used alone as described in Japanese Patent Laid-open Publication No. 11-16566, oxygen is released from the lithium-transition metal oxide and may cause an exothermic reaction with the electrolyte when exposed to a high-temperature environment in a state of charging if there is continuous charging due to abnormal charging or the like.

Currently, battery packs are equipped with internal protective circuits for maintaining safety in preparation for times when there are abnormalities as described above, and current and voltage are precisely controlled. Furthermore, the battery can itself is equipped with many protective mechanisms such as a positive temperature coefficient (PTC) device that prevents abnormal heat generation when there is excess current flow and a gas discharge valve with a current cutoff function providing for times when gas pressure rises inside the battery, and sufficient battery safety measures have been implemented. However, requirements have arisen for inhibiting the reaction between the positive electrode active material and the electrolyte from the standpoint of simplifying the protective mechanisms described above.

In Japanese Patent Laid-open Publication No. 5-151997 and Japanese Patent Laid-open Publication No. 5-182667, a method for increasing the reliability of the battery is proposed. Lithium carbonate is added to the lithium cobalt oxide and decomposes and generates gas during abnormal charging to cause the gas discharge valve to operate quickly and increase the reliability of the battery. Furthermore, in Japanese Patent Laid-open Publication No. 11-16566, addition of a metal such as Ti or Sn and an oxide such as TiO₂₋ₓ and SnO₂₋ₓ, to the lithium-transition metal oxide is proposed to absorb oxygen generated by the positive electrode active material. However, either of these methods invites a reduction in the discharge capacity of the positive active material, so they are not preferable from the standpoint of increasing energy density.

### OBJECT OF THE INVENTION

An object of the present invention is to provide a positive electrode active material for a nonaqueous electrolyte secondary battery which exhibits superior discharge properties and is capable of inhibiting reaction between the positive electrode active material and the electrolyte in a state of charging, and a positive electrode and a nonaqueous electrolyte secondary battery using the same.

### SUMMARY OF THE INVENTION

The present invention is a positive electrode material for a nonaqueous electrolyte secondary battery comprising a lithium-transition metal oxide having a layered structure and containing at least cobalt as a transition metal, wherein at least part of the surface of the lithium-transition metal oxide is coated with a treatment layer comprising low-temperature phase lithium cobalt oxide.

### BRIEF DESCRIPTION OF THE DRAWINGS

FIG. 1 is a drawing showing the discharge curve for the first cycle of a nonaqueous electrolyte secondary battery according to the present invention.

FIG. 2 is a SEM photograph showing the positive electrode active material in an example according to the present invention.

FIG. 3 is a SEM photograph showing the positive electrode material in a comparative example.

FIG. 4 is a schematic cross-section showing a nonaqueous electrolyte secondary battery in the example according to the present invention.

### EXPLANATION OF THE ELEMENTS

1: negative electrode (counter electrode)

2: positive electrode (working electrode)

3: separator

4: battery case

4a: bottom part

4b: cover

5: insulating packing

### DETAILED EXPLANATION OF THE INVENTION

According to the present invention, it is possible to inhibit reactions between the positive electrode material and the electrolyte during charging without lowering the discharge capacity by coating at least part of the surface of the lithium-transition metal oxide with a treatment layer comprising low-temperature phase lithium cobalt oxide.

According to the present invention, the following can be surmised about the mechanism for the increase in thermal stability resulting from the forming of the treatment layer described above on at least part of the surface of the lithium-transition metal oxide. More specifically, it is believed that oxygen is released from the surface of the lithium-transition metal oxide at high temperatures or abnormal charging. However, according to the present invention, the active oxygen present on the surface of the lithium-transition metal oxide interacts with the lithium and cobalt in the treatment layer comprising low-temperature phase lithium cobalt oxide formed on the surface of the lithium-transition metal oxide. The result is that oxygen is not easily released and reaction between the positive electrode active material and the electrolyte is inhibited.

Furthermore, it is believed that since the low-temperature phase lithium cobalt oxide which forms the treatment layer has the capacity to occlude and release lithium, it can mitigate the reduction in the discharge capacity of the positive electrode active material.

Nickel-cobalt composite oxides (LiNi₁₋ₓCoₓO₂), lithium cobalt oxide (LiCoO₂) and composite oxides where other transition metals are substituted for nickel and cobalt can be illustrated as lithium-transition metal oxides useful in the present invention. Furthermore, composite oxides where cobalt and manganese are substituted for nickel and composite oxides where nickel and manganese are substituted for cobalt can also be illustrated. Of these, lithium cobalt oxide is preferable.

A reason for lithium cobalt oxide being especially preferred is that disorder at the interface between the particle surface and surface of the treatment layer is inhibited because the interface is formed from identical ions when the lithium cobalt oxide surface is coated with low-temperature phase lithium cobalt oxide. As a result, the diffusion path for lithium in the junction is preserved and favorable load characteristics are obtained.

The low-temperature phase lithium cobalt oxide in the present invention is a lithium cobalt oxide obtained when a lithium compound and a cobalt compound are heat treated in a 300˜600° C. atmosphere and having a discharge capacity in the neighborhood of a potential of 3.3˜3.9 V relative to metallic lithium. Furthermore, the low-temperature phase lithium cobalt oxide in the present invention has a structure similar to the spinel structures discussed in Materials Research Bulletin, 28, previously presented. 235-246, 1992, and Solid State Ionics, 62, pp. 53-60, 1993. However, the publications mentioned above describe a crystal structure for lithium cobalt oxide when heat treated at 400° C., and the low-temperature phase lithium cobalt oxide in the present invention is not limited to the crystal structures disclosed in-the publications.

Furthermore, high-temperature lithium cobalt oxide is obtained using heat treatment temperatures higher than for low-temperature lithium cobalt oxide, and is the lithium cobalt oxide having a layered structure conventionally used as the positive electrode active material in lithium secondary batteries. The high-temperature phase lithium cobalt oxide has a discharge capacity in the neighborhood of a potential of 3.8˜4.3 V relative to metallic lithium.

Moreover, the low-temperature phase lithium cobalt oxide in the present invention improves the structural stability and electrochemical properties thereof, so suitable addition of elements such as Ni and Mn is possible.

The cobalt content of the treatment layer in the present invention is preferably 0.01˜20 atomic % and, more preferably, 0.05˜15 atomic % based on the transition metal in the lithium-transition metal oxide. If the cobalt content in the treatment layer is excessive, there is a danger of reducing the discharge capacity of the positive electrode active material. Furthermore, if the cobalt content of the treatment layer is too low, a sufficient thermal stability improvement effect may not be obtained through the surface treatment.

The positive electrode active material after surface treatment in the present invention, has a peak intensity I₅₉₅ in the neighborhood of 595 cm⁻¹ calculated using Raman spectrometry and a peak intensity I₄₅₀ in the neighborhood of 450 cm⁻¹, but a range of 0.001<I₄₅₀/I₅₉₅<0.7 is preferable. More preferable is a range of 0.01<I₄₅₀/I₅₉₅<0.5. The peak in the neighborhood of 595 cm⁻¹ is caused by vibration of the lithium-transition metal oxide along the c-axis, and the peak in the neighborhood of 450 cm⁻¹ is caused by the low-temperature phase lithium cobalt oxide.

The peak intensities from Raman spectrometry mentioned above are values when laser Raman spectrometry measurements were made under the following conditions. Measurements were made three or more times, and each value is an average thereof. Moreover, a Horiba Jobin Yvon T64000 was used for the measurement apparatus.

Measurement mode: Microraman

Beam diameter: 100 μm

Light source: Ar+laser/514.5 nm

Laser power: 10 mW

Diffraction grating: Spectrograph 1800 gr/mm

Dispersion: Single 7 A/mm

Slit: 100 μm

Detector: CCD (Jobin Yvon 1024×256)

Moreover, compounds formed by the reaction of the lithium-transition metal oxide and lithium cobalt oxide other than low-temperature lithium cobalt oxide may be included in the treatment layer in the present invention when the surface of the lithium-transition metal oxide is treated. Furthermore, coating of at least a part of the surface of the lithium-transition metal oxide is sufficient, and the entire surface need not be coated.

There are no particular limitations to the method for forming the treatment layer on the surface of the lithium-transition metal oxide, but, for example, the following methods can be used. Specifically, a transition metal oxide containing an excess of lithium is prepared in advance, and after a fixed amount of a cobalt compound is added, it is mixed and the low-temperature phase lithium cobalt oxide is formed on the surface through heat treatment.

The heat treatment described above is preferably in the range of 200˜700° C., and more preferably in the range of 300˜600° C. The heat treatment time is preferably 1˜30 hours. When the heat treatment temperature and heat treatment time fall below these ranges, there will be insufficient formation of the treatment layer. When the heat treatment temperature and heat treatment time exceed these ranges, the low-temperature phase lithium cobalt oxide undergoes a structural change to high-temperature phase lithium cobalt oxide, and inhibition of the reaction between the positive electrode active material and the electrolyte, which is a primary advantage of the present invention, may not be sufficiently obtained.

The method of mixing a predetermined amount of a cobalt compound and a lithium compound into a lithium-transition metal oxide not having an excess lithium content, that is, a lithium-transition metal oxide where the lithium content is 0.9<Li/M<1.1 (M being the transition metal), and reacting the cobalt compound and the lithium compound to form the low-temperature phase lithium cobalt oxide can be cited as another method for forming the low-temperature phase lithium cobalt oxide. Furthermore, a method of manufacturing low-temperature phase lithium cobalt oxide in advance, mixing this with a lithium-transition metal oxide and making the low-temperature phase lithium cobalt oxide adhere to the surface of the lithium-transition metal oxide, for example, can be cited as another method therefore. A mechanochemical method, for example, can be illustrate as the mixing method in this instance.

The positive electrode for the nonaqueous electrolyte secondary battery according to the present invention is characterized by including the positive electrode material according to the present invention as described above.

The positive electrode according to the present invention uses the positive electrode active material according to the present invention as described above and can be prepared in a manner similar to that for the positive electrodes for conventional nonaqueous electrolyte secondary batteries. More specifically, the positive electrode can be prepared by preparing a slurry by mixing the positive electrode active material described above, a binder and, as necessary, a conductive agent and drying the slurry after applying the slurry to a positive electrode current collector.

When there is a carbon material contained as a conductive agent, the carbon material content of the conductive agent is preferably 7% by weight or less based on the total of the positive electrode material, conductive agent and adhesive and, more preferably, is 5% by weight or less. This is because the capacity decreases if the amount of conductive agent increases excessively. Furthermore, it is not preferable for the amount of conductive agent to be 1% by weight or less. This is because, if there is too little conductive agent, there is a drop in the conductivity of the positive electrode and utilization is reduced.

The nonaqueous electrolyte secondary battery according to the present invention is characterized by being provided with a positive electrode according to the present invention as described above, a negative electrode and a nonaqueous electrolyte.

Negative electrode materials used conventionally in nonaqueous electrolyte secondary batteries can be used as the negative electrode material in the present invention. Metallic lithium, lithium alloys such as lithium-aluminum alloy, lithium-lead alloy, lithium-silicon alloy, and lithium tin alloy, carbon materials such as graphite, and coke and metal oxides, such as SnO₂, SnO, and TiO₂, having a potential that is lower than the positive electrode active material, for example, can be illustrated.

Solvents used conventionally in nonaqueous electrolyte secondary batteries, for example, can be used as the solvent for the nonaqueous electrolyte used in the present invention. Ethylene carbonate, propylene carbonate, 1,2-butylene carbonate, 2,3-butylene carbonate and other cyclic carbonates, γ-butyrolactone, propanesultone and other cyclic esters, ethylmethyl carbonate, diethyl carbonate, dimethyl carbonate and other chain carbonates, 1,2-dimethoxyethane, 1-2-diethoxyethane, diethyl ether, ethylmethyl ether and other chain ethers, methyl acetate, ethyl acetate, propyl acetate, methyl propionate, ethyl propionate, tetrahydrofuran, 2-methyltetrahydrofuran, 1,4-dioxane, acetonitrile and the like can be mentioned as the solvents.

Moreover, if vinylene carbonate, vinylethylene carbonate or the like is used by being added to the nonaqueous electrolyte, a coating with superior stability in lithium ion permeability is formed on the surface of the negative electrode.

Lithium salts conventionally used as solutes in nonaqueous electrolyte secondary batteries, for example, can be used as the solute for the nonaqueous electrolyte used in the present invention. LiPF₆, LiBF₄, LiCF₃SO₃, LiClO₄, LiN(C₂F₅SO₂)₂, LiN(CF₃SO₂) (C₄F₉SO₂) LiC(CF₃SO₂)₃, LiC(C₂F₅SO₂)₃, LiAsF₆, Li₂B₁₀Cl₁₀Li₂B₁₂Cl₁₂, LiB(C₂O₄)₂ and the like can be illustrated as these lithium salts.

### ADVANTAGE OF THE INVENTION

According to the present invention, the positive electrode active material having excellent charge discharge characteristics and enable to inhibit the reaction between the positive electrode active material and the electrolyte during charging can be obtained by coating at least part of the surface of the lithium-transition metal oxide with the treatment layer comprising the low-temperature phase lithium cobalt oxide.

### DESCRIPTION OF PREFERRED EMBODIMENTS

Embodiments of the present invention are explained in detail below. It is of course understood that the present invention is not limited to the batteries described in the following examples, but can be modified within the scope and spirit of the appended claims.

### EXAMPLE 1

### Preparation of the Positive Electrode Active Material

Li₂CO₃ and Co₃O₄ were mixed at an Li:Co mole ratio of 1.1:1 using an Ishikawa mixing mortar, and lithium cobalt oxide. (Li_{1.1}CoO₂) was obtained by pulverization after heat treatment for 24 hours at 850° C. in an air atmosphere.

The following treatment was carried out for the lithium cobalt oxide obtained. The lithium cobalt oxide (Li_{1.1}CoO₂) and CoCO₃ were weighed and mixed such that the Li_{1.1}CoO₂) :CoCO₃ mole ratio was 1:0.1. Next, the mixed powder was heat treated at 400° C. for 24 hours to obtain lithium cobalt oxide having a treatment layer of low-temperature phase lithium cobalt oxide formed thereon. In this positive electrode active material, the cobalt content in the treatment layer was 10 atomic % of the transition metal (cobalt) in the lithium cobalt oxide, which is the lithium-transition metal oxide.

Moreover, as a result of laser Raman spectrometry measurements for the positive electrode material obtained, the peak intensity ratio I₄₅₀ and I₅₉₅ was 0.35.

### Preparation of the Positive Electrode

After adding carbon as a conductive agent, polyvinylidene fluoride as an adhesive and N-methyl-2-pyrrolidone as a dispersion medium to the positive electrode active material obtained as described above such that the ratio by weight of the active material, conductive agent and adhesive was 90:5:5, a positive electrode slurry was prepared by kneading. After the slurry thus prepared was applied to an aluminum foil for the current collector, the positive electrode (working electrode) was prepared by drying followed by rolling using a pressure roller and cutting out a circular disk having a diameter of 20 mm. Moreover, the carbon material content was 5% by weight of the total of the positive electrode active material, the conductive agent and the adhesive.

### Preparation of the Negative Electrode

The negative electrode (counter electrode) was prepared by stamping a disk 20 mm in diameter from a rolled lithium plate with a predetermined thickness.

### Preparation of the Electrolyte

The nonaqueous electrolyte was prepared by forming a solution having a concentration of lithium hexafluorophosphate (LiPF₆) of 1.0 mole per liter in a mixed solvent of ethylene carbonate and ethyl carbonate in a ratio of 40:60 by volume.

### Preparation of the Test Cell

A separator 3 comprising a porous polyethylene film was sandwiched between the positive electrode (working electrode) 2 and the negative electrode (counter electrode)1 as shown in FIG. 4. Next, along with bringing the positive electrode current collector 2a into contact with the upper cover 4b of the battery case for the test cell, the negative electrode 1 described above was brought into contact with the bottom part 4a of the battery case 4. These were accommodated within the battery case 4, and the upper cover 4b described above and the bottom part were electrically insulated from each other with insulating packing 5, to prepare a test cell (nonaqueous electrolyte secondary battery) A1 according to the present invention.

### COMPARATIVE EXAMPLE 1

A comparative test cell B1 was prepared in the same manner as Example 1 except that the positive electrode active material was lithium cobalt oxide (Li_{1.1}CoO₂) obtained from the preparation of the positive electrode active material in Example 1 used as is without a surface treatment.

### COMPARATIVE EXAMPLE 2

A comparative test cell B2 was prepared in the same manner as Example 1 except that lithium cobalt oxide (LiCoO₂) was prepared with a Li:Co ratio of 1:1 in the preparation of the positive electrode active material in Example 1 and the positive electrode active material was used as is without surface treatment.

### Evaluation of Charge and Discharge Characteristics

The test cells prepared were charged until they reached a voltage of 4.2 V using a constant current of 0.75 mA/cm² at 25° C. Subsequently, the test cells were discharged until they reached a voltage of 2.75 V at a constant current of 0.75 ma/cm². The initial discharge capacity (mAh/g) of each of the cells was measured, and the results are given in Table 1.

TABLE 1

| Test Cell | Positive Electrode | Discharge Capacity |
|---|---|---|
| A1 | Li_{1.1}CoO₂ + 0.1 CoCO₃ | 99 |
| | Treatment (400° C., 20 hrs) | |
| B1 | Li_{1.1}CoO₂ | 97 |
| B2 | LiCoO₂ | 100 |

As is clear from the results in Table 1, test cell B1 that used lithium cobalt oxide (Li_{1.1}CoO₂) with increased lithium content had a discharge capacity slightly lower than test cell B2 that used LiCoO₂. It is believed that excess lithium was most likely present as lithium carbonate that does not contribute to charging and discharging.

Conversely, in test cell A1 where the positive electrode active material is lithium cobalt oxide (Li_{1.1}CoO₂) with increased lithium content having a treatment layer formed thereon, a discharge capacity substantially equal to that using conventional lithium cobalt oxide (LiCoO₂) was obtained. It is believed that the low-temperature phase lithium cobalt oxide contained in the treatment layer contributed to the discharge reaction due to the formation of that layer. It is understood from these results that a positive electrode active material that does not decrease the discharge capacity is obtained even with the formation of a treatment layer according to the present invention.

FIG. 1 shows the discharge curves for the first cycles for Example 1 test cell A1 and Comparative Example 2 test cell B2. From the initial discharge curve shown in FIG. 1, a change in the shape of the curve is found in the latter part of the discharge at 3.3˜3.9 (V vs. Li/Li+) for test cell A1 in Example 1. This change is believed to correspond to the low-temperature phase lithium cobalt oxide reaction. Therefore, it can be seen that low-temperature phase lithium cobalt oxide has been produced in the positive electrode material in Example 1.

### Scanning Electron Microscope Observations

Scanning electron microscope (SEM) observations were made on the positive electrode active material prepared in Example 1 and the positive electrode active material prepared in Comparative Example 2.

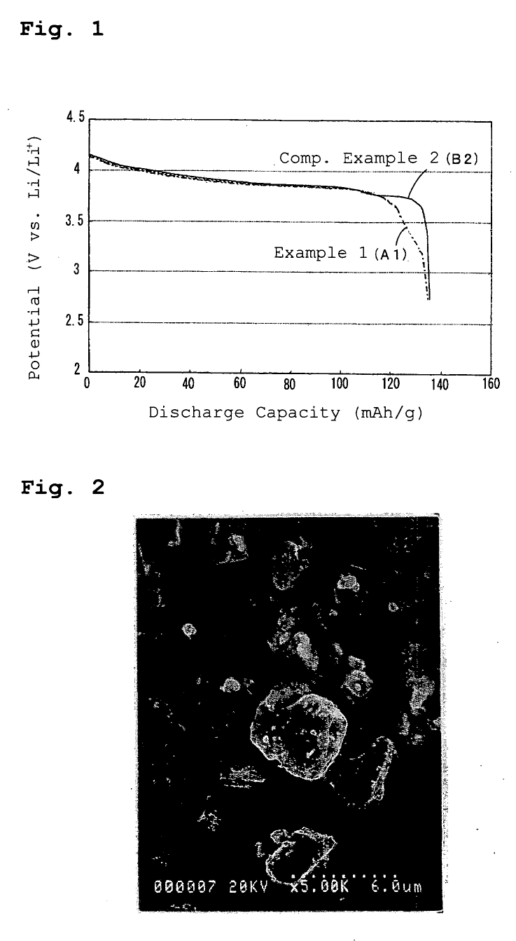

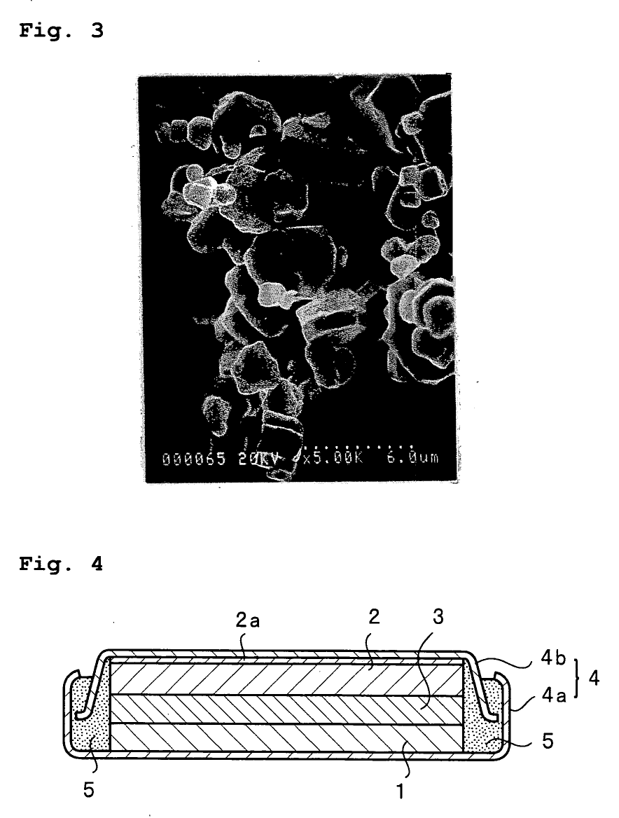

FIG. 2 shows the positive electrode active material for Example 1 and FIG. 3 shows the positive electrode material for Comparative Example 2. As is clear from a comparison of FIG. 2 and FIG. 3, a large number of particles are found on the surface of the positive electrode active material in FIG. 2. The particles are thought to be low-temperature phase lithium cobalt oxide. Therefore, it can be seen that a treatment layer comprising low-temperature phase lithium cobalt oxide has been formed in the positive electrode active material in Example 1.

### DSC Analysis

Differential scanning calorimetric (DSC) analysis was performed to measure the starting temperature for the reaction between the positive electrode active material and the electrolyte. First, each test cell was charged at a constant current of 0.75 mA/cm² until 4.25 V was reached. Next, each test cell was dismantled, and after removing the positive electrode, the positive electrode mixture layer was separated from the aluminum foil and DSC analysis was carried out with the electrolyte still adhering to it. The starting temperature for heat generated, the calorific value and the presence or absence of heat generated in the range of 100˜150° C. were measured in the DSC analysis. The measurement results are given in Table 2.

TABLE 2

| | | Temperature | | |
|---|---|---|---|---|
| | | at Start of | Amount of | Heat |
| | | Heat | Heat | Generated |
| Test | Positive | Generation | Generated | between |
| Cell | Electrode | (° C.) | (J/g) | 100˜150° C. |
| A1 | Li_{1.1}CoO₂ + | 190 | 510 | None |
| | 0.1 CoCO₃ | | | |
| | Treatment | | | |
| | (400° C., | | | |
| | 20 hrs) | | | |
| B1 | Li_{1.1}CoO₂ | 180 | 430 | 103 J/g |
| B2 | LiCoO₂ | 145 | 780 | None |

As shown in Table 2, heat generation was observed in the neighborhood of 145° C. in test cell B2 that used conventional lithium cobalt oxide (LiCoO₂) for the positive electrode active material. In test cell B1 that used lithium cobalt oxide (Li_{1.1}CoO₂) with increased lithium content, the starting temperature for the heat generation was higher at 180° C., but a small amount of heat generation was observed in the neighborhood of 100˜150° C. This small amount of heat generation is likely due to the reaction of the lithium carbonate present on the surface of the positive electrode active material with the electrolyte.

Conversely, in test cell A1 using the positive electrode material according to the present invention, the starting temperature for the heat generation was surprisingly high at 190° C. and was higher than that for the lithium cobalt oxide (Li_{1.1}CoO₂) without surface treatment. Furthermore, any amount of heat generation was not found in the neighborhood of 100˜150° C. The reason for this is likely the consumption of the lithium carbonate present on the surface of the positive electrode active material due to the reaction with cobalt carbonate added during surface treatment. Furthermore, it can be assumed that the treatment layer comprising the low-temperature phase lithium cobalt oxide is formed on the positive electrode surface because the lithium carbonate and cobalt carbonate react and, as a result, oxygen release from the lithium cobalt oxide having a layered structure is inhibited, and the starting temperature for the reaction with the electrolyte increased.

More specifically, it is believed that it was possible to inhibit the reaction between the positive electrode active material and the electrolyte without reducing the discharge capacity by forming a treatment layer comprising low-temperature phase lithium cobalt oxide on the surface of the lithium cobalt oxide having a layered structure.

In the example described above, a battery using metallic lithium for the negative electrode was prepared, and the discharge capacity and the starting temperature for heat generated by reaction with the electrolyte was examined, but similar results were obtained when alloys occluding and discharging lithium ions, carbon materials or the like were used for the negative electrode. Furthermore, there are no particular limits on the shape of the battery, and the present invention can be applied broadly to nonaqueous electrolyte secondary batteries with a variety of shapes, including cylindrical shapes, rectangular shapes, flat shapes and the like.

This application claims priority of Japanese Patent Application No. 2004-274428 filed Sep. 22, 2004, which is incorporated herein by reference.

What is claimed is:

1. A positive electrode active material for a nonaqueous electrolyte secondary battery comprising a lithium-transition metal oxide having a layered structure and containing at least cobalt as a transition metal, wherein at least part of the surface of said lithium-transition metal oxide is coated with a treatment layer comprising low-temperature phase lithium cobalt oxide.

2. The positive electrode active material for a nonaqueous electrolyte secondary battery according to claim 1, wherein said low-temperature phase lithium cobalt oxide has a spinel structure.

3. The positive electrode active material for a nonaqueous electrolyte secondary battery according to claim 1, wherein the cobalt content of said treatment layer is 0.01˜20 atomic % of the transition metal in said lithium-transition metal oxide.

4. The positive electrode active material for a nonaqueous electrolyte secondary battery according to claim 2, wherein the cobalt content of said treatment layer is 0.01˜20 atomic % of the transition metal in said lithium-transition metal oxide.

5. The positive electrode active material for a nonaqueous electrolyte secondary battery according to claim 1, wherein said lithium-transition metal oxide is lithium cobalt oxide.

6. The positive electrode active material for a nonaqueous electrolyte secondary battery according to claim 2, wherein said lithium-transition metal oxide is lithium cobalt oxide.

7. The positive electrode active material for a nonaqueous electrolyte secondary battery according to claim 3, wherein said lithium-transition metal oxide is lithium cobalt oxide.

8. The positive electrode active material for a nonaqueous electrolyte secondary battery according to claim 4, wherein said lithium-transition metal oxide is lithium cobalt oxide.

9. A positive electrode for a nonaqueous electrolyte secondary battery, comprising the positive electrode active material according to claim 1.

10. A positive electrode for a nonaqueous electrolyte secondary battery, comprising the positive electrode active material according to claim 2.

11. A positive electrode for a nonaqueous electrolyte secondary battery, comprising the positive electrode active material according to claim 3.

12. A positive electrode for a nonaqueous electrolyte secondary battery, comprising the positive electrode active material according to claim 4.

13. A nonaqueous electrolyte secondary battery, comprising the positive electrode according to claim 9 is contained.

14. A nonaqueous electrolyte secondary battery, comprising the positive electrode according to claim 10, a negative electrode and a nonaqueous electrolyte.

15. A nonaqueous electrolyte secondary battery, comprising the positive electrode according to claim 11, a negative electrode and a nonaqueous electrolyte.

16. A nonaqueous electrolyte secondary battery, comprising the positive electrode according to claim 12, a negative electrode and a nonaqueous electrolyte.
